(19) United States
(12) Patent Application Publication
(10) Pub. No.: US 2023/0314977 A1
(43) Pub. Date: Oct. 5, 2023

(54) CARRIER FOR ELECTROSTATIC IMAGE DEVELOPMENT, ELECTROSTATIC IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Karin SAKAI, Kanagawa (JP); Kazutsuna SASAKI, Kanagawa (JP); Yosuke TSURUMI, Kanagawa (JP); Yasuo KADOKURA, Kanagawa (JP); Takuro WATANABE, Kanagawa (JP)

(73) Assignee: FUJIFILM Business Innovation Corp., Tokyo (JP)

(21) Appl. No.: 17/985,612

(22) Filed: Nov. 11, 2022

(30) Foreign Application Priority Data
Mar. 29, 2022 (JP) 2022-054213

(51) Int. Cl. G03G 9/113; G03G 15/08

(52) U.S. Cl. CPC G03G 9/1135; G03G 9/1139; G03G 9/1138; G03G 15/08

(57) ABSTRACT

A carrier for electrostatic image development includes: a core material; and a resin coating layer that contains nitrogen-containing silica particles and nitrogen-containing resin fine particles and covers the core material. The content of the nitrogen-containing silica particles is from 10% by mass to 55% by mass inclusive based on the total mass of the resin coating layer. The nitrogen-containing resin fine particles have a volume average particle diameter of from 100 nm to 250 nm inclusive. The mass ratio P/S of the mass P of the nitrogen-containing resin fine particles to the mass S of the nitrogen-containing silica particles is from 0.15 to 0.55 inclusive.

### CROSS-REFERENCE TO RELATED APPLICATIONS

This application is based on and claims priority under 35 USC 119 from Japanese Patent Application No. 2022-054213 filed Mar. 29, 2022.

### BACKGROUND

### (i) Technical Field

The present disclosure relates to a carrier for electrostatic image development, an electrostatic image developer, a process cartridge, an image forming apparatus, and an image forming method.

### (ii) Related Art

Japanese Unexamined Patent Application Publication No. 2021-51216 discloses a carrier for electrostatic image development including a core material and a coating resin layer that contains nitrogen-containing resin particles and inorganic oxide particles and covers the core material. In this carrier, the surface exposure ratio of the nitrogen-containing resin particles is from 0.8% to 3.0% inclusive.

Japanese Unexamined Patent Application Publication No. 2001-51454 discloses a carrier for electrostatic latent image development including core particles and a matrix resin covering the surface of the core particles. The matrix resin contains two or more types of nitrogen-containing fine particles. The average primary particle diameter of the fine particles with larger diameters is in the range of 0.1 to 3.0 μm, and the average primary particle diameter of the fine particles with smaller diameters is in the range of 0.01 to 0.1 μm. The ratio between these average primary particle diameters is in the range of 300:1 to 2:1.

### SUMMARY

When a large amount of fine particles are added to a resin coating layer of a carrier, the strength of the coating layer is increased due to the filler effect, and the carrier is prevented from being contaminated with external additives adhering to a toner. This gives the effect of improving the charge retention ability of the carrier. However, when the carrier experiences high stress, e.g., when the area ratio of an image, i.e., the area coverage of the image, on a sheet is low, e.g., 1%, when a short print job in which printing is performed on about 100 sheets is repeated, or when printing is performed continuously on a large number of sheets, e.g., 50000 or more sheets, the resin coating layer containing the fine particles may peel off, so that the charge retention ability may deteriorate.

Aspects of non-limiting embodiments of the present disclosure relate to a carrier including a resin coating layer containing nitrogen-containing silica particles and nitrogen-containing resin fine particles. In this carrier, deterioration of the charge retention ability of the carrier is less than that when the content of the nitrogen-containing silica particles is less than 10% by mass or more than 55% by mass based on the total mass of the resin coating layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a carrier for electrostatic image development including: a core material; and a resin coating layer that contains nitrogen-containing silica particles and nitrogen-containing resin fine particles and covers the core material, wherein the content of the nitrogen-containing silica particles is from 10% by mass to 55% by mass inclusive based on the total mass of the resin coating layer, wherein the nitrogen-containing resin fine particles have a volume average particle diameter of from 100 nm to 250 nm inclusive, and wherein the mass ratio P/S of the mass P of the nitrogen-containing resin fine particles to the mass S of the nitrogen-containing silica particles is from 0.15 to 0.55 inclusive.

### BRIEF DESCRIPTION OF THE DRAWINGS

Exemplary embodiments of the present disclosure will be described in detail based on the following figures, wherein:

FIG. 1 is a schematic configuration diagram showing an example of an image forming apparatus according to an exemplary embodiment; and

FIG. 2 is a schematic configuration diagram showing an example of a process cartridge detachably attached to the image forming apparatus according to the exemplary embodiment.

### DETAILED DESCRIPTION

Exemplary embodiments of the disclosure will be described below. The description, Examples, etc. are illustrative of the exemplary embodiments and are not intended to limit the scope of the disclosure.

In the present disclosure, the phrases “from XXX to YYY inclusive” and “XXX to YYY” mean a numerical range including the upper and lower limits specified, unless otherwise noted. In the present disclosure, when reference is made to the amount of a component in a composition, if the composition contains a plurality of materials corresponding to the component, the amount means the total amount of the plurality of materials, unless otherwise noted.

In the present disclosure, a “carrier for electrostatic image development” may be referred to simply as a “carrier,” and a “toner for electrostatic image development” may be referred to simply as a “toner.” Moreover, an “electrostatic image developer” may be referred to simply as a “developer.”

### Carrier for Electrostatic Image Development

A carrier for electrostatic image development according to an exemplary embodiment includes: a core material; and a resin coating layer that contains nitrogen-containing silica particles and nitrogen-containing resin fine particles and covers the core material. The content of the nitrogen-containing silica particles is from 10% by mass to 55% by mass inclusive based on the total mass of the resin coating layer, and the nitrogen-containing resin fine particles have a volume average particle diameter of from 100 nm to 250 nm inclusive. The mass ratio P/S of the mass P of the nitrogen-containing resin fine particles to the mass S of the nitrogen-containing silica particles is from 0.15 to 0.55 inclusive.

When the resin coating layer covering the core material of the carrier for electrostatic image development contains a large amount of fine particles such as inorganic oxide particles and resin fine particles, the strength of the resin coating layer is improved due to the filler effect, and irregularities tend to be formed on the surface of the carrier, so that the carrier is prevented from being contaminated with external additives adhering to a toner. This gives the effect of improving the charge retention ability of the carrier.

However, under the condition that the carrier experiences high stress, e.g., when the area ratio of an image, i.e., the area coverage of the image, on a sheet is low, e.g., 1%, when a short print job in which printing is performed on about 100 sheets is repeated, or when a long running job is performed in which printing is performed continuously on a large number of sheets, e.g., 50000 or more sheets, the resin coating layer may peel off even when the resin coating layer of the carrier contains the fine particles. As the peeling proceeds, the charge retention ability of the developer as a whole may deteriorate.

The carrier according to the present exemplary embodiment has the structure described above. In this case, even in an environment in which the carrier experiences high stress and the resin coating layer of the carrier may easily peel off, deterioration of the charge retention ability can be reduced. The mechanism of this may be as follows.

In the present exemplary embodiment, the resin coating layer contains the nitrogen-containing silica particles and the nitrogen-containing resin fine particles. The nitrogen element contained in the nitrogen-containing silica particles and the nitrogen element contained in the nitrogen-containing resin fine particles repel each other. In this case, the particles are well-dispersed, and segregation of the particles in the resin coating layer is prevented, so that the filler effect increases. Therefore, even in a high-stress environment in which the resin coating layer may easily peel off (for example, the area coverage is low), the nitrogen-containing silica particles are always present uniformly on the surface of the resin coating layer, and this may be the reason that the charge retention ability of the carrier provided is good.

Titanate compound particles may be used as the inorganic particles in the carrier. However, in the present exemplary embodiment, the nitrogen-containing inorganic particles are not titanate compound particles, and the silica particles are responsible for the effect on the charge retention ability. The reason for this may be as follows. Titanium is more positively chargeable than silica. Therefore, with nitrogen-containing titanate particles, the positive chargeability of titanium is added to the positive chargeability of the nitrogen element, and the repulsion between the nitrogen element in the nitrogen-containing titanate particles and the nitrogen element in the other particles is excessively large, so that the dispersibility of the particles may deteriorate. In this case, titanium having good charge exchangeability is segregated on the surface of the resin coating layer, and the charge retention ability may deteriorate.

The structure of the carrier according to the present exemplary embodiment will be described in detail.

### Core Material

The carrier for electrostatic image development according to the present exemplary embodiment includes the core material.

No particular limitation is imposed on the core material so long as it has magnetism, and a well-known material used as a core material of a carrier may be used.

Examples of the core material include: particulate magnetic powders (magnetic particles); resin-impregnated magnetic particles obtained by impregnating a porous magnetic powder with a resin; and magnetic powder-dispersed resin particles obtained by dispersing a magnetic powder in a resin. One core material may be used alone, or a combination of two or more may be used.

Examples of the magnetic particles include: particles of magnetic metals such as iron, nickel, and cobalt; and magnetic oxides such as ferrite and magnetite. The magnetic particles may be magnetic oxide particles.

Examples of the resin forming the core material include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicones having organosiloxane bonds and modified products thereof, fluorocarbon resins, polyesters, polycarbonates, phenolic resins, and epoxy resins. One of these resins may be used alone, or two or more of them may be used in combination. The resin forming the core material may contain an additive such as electrically conductive particles. Examples of the electrically conductive particles include: particles of metals such as gold, silver, and copper; and particles of carbon black, titanium oxide, zinc oxide, tin oxide, barium sulfate, aluminum borate, and potassium titanate.

The core material may be a particulate magnetic powder, i.e., magnetic particles.

The volume average particle diameter of the magnetic particles may be, for example, from 20 μm to 50 μm inclusive.

### Resin Coating Layer

The resin coating layer in the present exemplary embodiment contains the nitrogen-containing silica particles and the nitrogen-containing resin fine particles.

The resin coating layer in the present exemplary embodiment is a resin layer that covers the core material.

### Binder Resin

Examples of a binder resin forming the resin coating layer include: styrene-acrylic acid copolymers; polyolefin resins such as polyethylene and polypropylene; polyvinyl and polyvinylidene resins such as polystyrene, acrylic resins, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymers; straight silicone resins having organosiloxane bonds and modified products thereof; fluorocarbon resins such as polytetrafluoroethylene, polyvinyl fluoride, polyvinylidene fluoride, and polychlorotrifluoroethylene; polyesters; polyurethanes; polycarbonates; amino resins such as urea-formaldehyde resins; and epoxy resins. Only one resin may be used as the resin forming the resin coating layer, or a combination of two or more may be used.

The resin forming the resin coating layer may include an alicyclic (meth)acrylic resin. When the resin coating layer contains an alicyclic (meth)acrylic resin, the dispersibility of the inorganic oxide particles contained in the resin coating layer tends to be high, and resin pieces containing the inorganic oxide particles tend to be generated efficiently. In this case, density unevenness in images tends to be further reduced.

The monomer component of the alicyclic (meth)acrylic resin may be a lower alkyl ester of (meth)acrylic acid (e.g., an alkyl (meth)acrylate in which the number of carbon atoms in the alkyl group is from 1 to 9 inclusive). Specific examples include methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, and 2-(dimethylamino)ethyl (meth)acrylate.

In particular, from the viewpoint of further reducing density unevenness in images, the alicyclic (meth)acrylic resin contains, as the monomer component, preferably at least one selected from the group consisting of methyl (meth)acrylate, cyclohexyl (meth)acrylate, and 2-(dimethylamino)ethyl (meth)acrylate and more preferably at least one of methyl (meth)acrylate and cyclohexyl (meth)acrylate. One monomer component may be used for the alicyclic (meth)acrylic resin, or a combination of two or more may be used.

The alicyclic (meth)acrylic resin blocks the influence of water on a polarization component of the bond between carbon and oxygen atoms through the steric hindrance of the alicyclic functional group. The alicyclic (meth)acrylic resin may contain cyclohexyl (meth)acrylate as the monomer component because the influence of water when an environmental change occurs can be reduced.

The content of cyclohexyl (meth)acrylate contained in the alicyclic (meth)acrylic resin is preferably from 75% by mole to 100% by mole inclusive, more preferably from 90% by mole to 100% by mole inclusive, and still more preferably from 95% by mole to 100% by mole inclusive.

Examples of the method for forming the resin coating layer on the surface of the core material include a wet production method and a dry production method. The wet production method uses a solvent that can dissolve or disperse the resin forming the resin coating layer. The dry production method does not use the solvent.

Examples of the dry production method include: an immersion method in which the core material is immersed in a resin solution for forming the resin coating layer to thereby coat the core material with the resin; a spray method in which the resin solution for forming the resin coating layer is sprayed onto the surface of the core material; a fluidized bed method in which the resin solution for forming the resin coating layer is sprayed onto the core material floating in a fluidized bed; and a kneader-coater method in which the core material and the resin solution for forming the resin coating layer are mixed in a kneader coater and then the solvent is removed.

The resin solution for forming the resin coating layer used in the wet production method is prepared by dissolving or dispersing the resin and an additional component in the solvent. No particular limitation is imposed on the solvent, so long as it can dissolve or disperse the resin. Examples of the solvent include: aromatic hydrocarbons such as toluene and xylene; ketones such as acetone and methyl ethyl ketone; and ethers such as tetrahydrofuran and dioxane.

Examples of the dry production method include a method in which a dry mixture of the core material and the resin for forming the resin coating layer is heated to form the resin coating layer. Specifically, for example, the core material and the resin for forming the resin coating layer are mixed in air and heat-fused to form the resin coating layer.

The thickness of the resin coating layer is preferably from 0.1 μm to 10 μm inclusive, more preferably from 0.2 μm to 5 μm inclusive, and still more preferably from 0.3 μm to 3 μm inclusive.

The thickness T of the resin coating layer is measured by the following method. The carrier is embedded in, for example, an epoxy resin and cut with, for example, a diamond knife to thereby produce a thin slice. The thin slice is observed under, for example, a transmission electron macroscope (TEM), and cross-sectional images of a plurality of carrier particles are taken. The thickness of the resin coating layer is measured at 20 points in the cross-sectional images of the carrier particles, and the average of the measured values is used.

### Nitrogen-Containing Silica Particles

The nitrogen-containing silica particles contained in the resin coating layer are prepared, for example, by causing a nitrogen-containing material to react with or adhere to silica particles to thereby introduce the nitrogen element. The nitrogen-containing material may be used for the surface treatment of the silica particles.

The nitrogen-containing material used for the surface treatment of the fine core particles may be a silane coupling agent having a nitrogen-containing functional group or a vinyl-based copolymer synthesized using a (meth)acrylic monomer having a nitrogen-containing functional group and a hydrolyzable alkoxy silanol group. The activity of hydroxy groups present on the surface of the silica particles is high, and hydrolysis of the silanol groups in the silane coupling agent or the silanol groups in the vinyl-based copolymer is thereby facilitated, so that no unreacted surface treatment agent remains on the surface of the silica particles. Therefore, the carrier having the resin coating layer produced by dispersing, in a matrix resin, the nitrogen-containing silica particles treated with the above surface treatment agent does not contain the unreacted silane coupling agent used for the silica particles. In this case, no silane coupling agent moves to the surface of the carrier over time, and an undesirable change in the charge retention ability of the carrier due to the silane coupling agent is prevented.

Examples of the nitrogen-containing functional group include an amino group, an amido group, an imido group, and an amidimido group. In particular, from the viewpoint of narrowing the distribution of charges in the silica particles to thereby improve the charge retention ability of the carrier, the nitrogen-containing functional group may be an amino group. Examples of the hydrolyzable alkoxy silanol group reactive with a hydroxy group include a trimethoxysilyl group, a triethoxysilyl group, a dimethoxysilyl group, and a diethoxysilyl group. Therefore, a silane coupling agent having an amino group and a hydrolyzable alkoxy silanol group may be used.

Specific examples of the silane coupling agent having a nitrogen-containing functional group and used in the present exemplary embodiment include the following compounds.
H₂N(CH₂)₃Si(OCH₃)₃
H₂N(CH₂)₃Si(OC₂H₅)₃
H₂N(CH₂)₃(CH₃)₂Si(OC₂H₅)
H₂N(CH₂)₃(CH₃)Si(OC₂H₅)₂
H₂N(CH₂)₂NH(CH₂)Si(OCH₃)₃
H₂N(CH₂)₂NH(CH₂)₃Si(OCH₃)₃
H₂N(CH₂)₂NH(CH₂)₂(CH₃)Si(OCH₃)₂
H₂NCONH(CH₂)₃Si(OCH₃)₃
H₂NCONH(CH₂)₃Si(OC₂H₅)₃
H₂N(CH₂)₂NH(CH₂)₂NH(CH₂)₃Si(OCH₃)₃
(CH₃)₂N(CH₂)₂(CH₃)Si(OC₂H₅)₂
(C₄H₉)₂N(CH₂)₃Si(OCH₃)₃
C₃H₇(CH₃)N(CH₂)₃Si(OCH₃)₃

From the viewpoint of improving the charge retention ability of the carrier, the content of the nitrogen-containing silica particles in the present exemplary embodiment is from 10% by mass to 55% by mass inclusive based on the total mass of the resin coating layer. The content is preferably from 13% by mass to 50% by mass inclusive and more preferably from 15% by mass to 45% by mass inclusive.

From the viewpoint of improving the charge retention ability of the carrier, the volume average particle diameter of the nitrogen-containing silica particles in the present exemplary embodiment is preferably from 5 nm to 20 nm inclusive, more preferably from 7 nm to 17 nm inclusive, and still more preferably from 8 nm to 15 nm inclusive.

The volume average particle diameter of the nitrogen-containing silica particles is determined by observing a cross section of the carrier that is obtained by cutting the carrier in the thickness direction of the resin coating layer under a scanning electron microscope and subjecting images of the silica particles to image analysis. Specifically, 50 nitrogen-containing silica particles per carrier particle are observed under the scanning electron microscope. Image analysis is performed to measure the maximum and minimum diameters of each of the nitrogen-containing silica particles, and the equivalent spherical diameter is determined from the intermediate value of the maximum and minimum diameters. The equivalent spherical diameter measurement is performed on 100 carrier particles. Then the 50% diameter (D50v) in a volume-based cumulative frequency distribution of the equivalent spherical diameters obtained is used as the volume average particle diameter of the silica particles.

Titanate compound particles may also be used as the inorganic particles for the carrier. However, when the titanate compound particles are used as the nitrogen-containing inorganic particles, the charge retention ability deteriorates. Therefore, in the present exemplary embodiment, the silica particles are used. The reason for this may be as follows. Titanium is more positively chargeable than silica. Therefore, with nitrogen-containing titanate particles, the positive chargeability of titanium is added to the positive chargeability of the nitrogen element, and the repulsion between the nitrogen element in the nitrogen-containing titanate particles and the nitrogen element in the other particles is excessively large, so that the dispersibility of the particles may deteriorate. In this case, titanium having good charge exchangeability is segregated on the surface of the resin coating layer, and the charge retention ability may deteriorate.

### Nitrogen-Containing Resin Fine Particles

Examples of the nitrogen-containing resin fine particles include: particles of (meth)acrylic-based resins prepared by polymerization of monomers including dimethylaminoethyl (meth)acrylate, dimethylacrylamide, acrylonitrile, etc.; particles of amino resins such as urea, melamine, guanamine, and aniline; particles of amide resins; particles of urethane resins; and particles of copolymers of the above resins. In particular, from the viewpoint of further reducing density unevenness in images, the nitrogen-containing resin fine particles include preferably at least one type of particles selected from the group consisting of amino resin particles and urethane resin particles, include more preferably amino resin particles, and include still more preferably melamine resin particles. Only one type of nitrogen-containing resin particles may be used, or a combination of two or more types may be used.

From the viewpoint of improving the charge retention ability of the carrier, the volume average particle diameter of the nitrogen-containing resin fine particles in the present exemplary embodiment is from 100 nm to 250 nm inclusive. The volume average particle diameter is preferably from 120 nm to 230 nm inclusive and more preferably from 140 nm to 220 nm inclusive. In particular, when the volume average particle diameter of the nitrogen-containing resin fine particles is 100 nm or more, irregularities can be easily formed on the surface of the carrier, so that adhesion of external additives of a toner to the carrier tends to be physically prevented.

The volume average particle diameter of the nitrogen-containing resin particles can be determined by the same method as that for the volume average particle diameter of the nitrogen-containing silica particles.

Let the volume average particle diameter of the nitrogen-containing resin fine particles in the present exemplary embodiment be D (μm), and the thickness of the resin coating layer be T (μm). Then, from the viewpoint of improving the charge retention ability of the carrier, D/T may be from 0.007 to 0.24 inclusive. D/T is preferably from 0.01 to 0.24 inclusive, more preferably from 0.02 to 0.24 inclusive, and still more preferably from 0.033 to 0.24 inclusive.

From the viewpoint of improving the charge retention ability of the carrier, the content of the nitrogen-containing resin particles in the present exemplary embodiment is preferably from 5% by mass to 30% by mass inclusive, more preferably from 6% by mass to 20% by mass inclusive, and still more preferably from 7% by mass to 15% by mass inclusive based on the total mass of the resin coating layer.

From the viewpoint of improving the charge retention ability of the carrier, the mass ratio P/S of the mass P of the nitrogen-containing resin fine particles to the mass S of the nitrogen-containing silica particles in the present exemplary embodiment is from 0.15 to 0.55 inclusive. The mass ratio P/S is preferably from 0.18 to 0.52 inclusive and more preferably from 0.20 to 0.50 inclusive.

### Electrostatic Image Developer

A developer according to an exemplary embodiment contains a toner and the carrier according to the preceding exemplary embodiment.

The developer according to the present exemplary embodiment is prepared by mixing the toner and the carrier according to the preceding exemplary embodiment at an appropriate mixing ratio. The mixing ratio (mass ratio) of the toner to the carrier (toner:carrier) is preferably 1:100 to 30:100 and more preferably 3:100 to 20:100.

### Toner for Electrostatic Image Development

No particular limitation is imposed on the toner, and any known toner is used. Examples of the toner include: a color toner including toner particles containing a binder resin and a coloring agent; and an infrared absorbing toner that uses an infrared absorber instead of the coloring agent. The toner may contain a release agent, various internal and external additives, etc.

### Binder Resin

Examples of the binder resin include: vinyl resins composed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene); and vinyl resins composed of copolymers of combinations of two or more of the above monomers.

Other examples of the binder resin include: non-vinyl resins such as epoxy resins, polyester resins, polyurethane resins, polyamide resins, cellulose resins, polyether resins, and modified rosins; mixtures of the non-vinyl resins and the above-described vinyl resins; and graft polymers obtained by polymerizing a vinyl monomer in the presence of any of these resins.

One of these binder resins may be used, or two or more of them may be used in combination.

The binder resin may be a polyester resin. The polyester resin is, for example, any known polyester resin.

The glass transition temperature (Tg) of the polyester resin is preferably from 50° C. to 80° C. inclusive and more preferably from 50° C. to 65° C. inclusive.

The glass transition temperature is determined using a DSC curve obtained by differential scanning calorimetry (DSC). More specifically, the glass transition temperature is determined from “extrapolated glass transition onset temperature” described in a glass transition temperature determination method in “Testing methods for transition temperatures of plastics” in JIS K7121-1987.

The weight average molecular weight (Mw) of the polyester resin is preferably from 5,000 to 1,000,000 inclusive and more preferably from 7,000 to 500,000 inclusive. The number average molecular weight (Mn) of the polyester resin may be from 2,000 to 100,000 inclusive. The molecular weight distribution Mw/Mn of the polyester resin is preferably from 1.5 to 100 inclusive and more preferably from 2 to 60 inclusive.

The weight average molecular weight and number average molecular weight of the polyester resin are measured by gel permeation chromatography (GPC). In the molecular weight distribution measurement by GPC, a GPC measurement apparatus HLC-8120GPC manufactured by TOSOH Corporation is used. A TSKgel Super HM-M (15 cm) column manufactured by TOSOH Corporation and a THF solvent are used. The weight average molecular weight and the number average molecular weight are computed from the measurement results using a molecular weight calibration curve produced using monodispersed polystyrene standard samples.

The content of the binder resin is preferably from 40% by mass to 95% by mass inclusive, more preferably from 50% by mass to 90% by mass inclusive, and still more preferably from 60% by mass to 85% by mass inclusive based on the total mass of the toner particles.

### Coloring Agent

Examples of the coloring agent include: pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine-based dyes, xanthene-based dyes, azo-based dyes, benzoquinone-based dyes, azine-based dyes, anthraquinone-based dyes, thioindigo-based dyes, dioxazine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes.

One coloring agent may be used alone, or two or more coloring agents may be used in combination.

The coloring agent used may be optionally subjected to surface treatment or may be used in combination with a dispersant. A plurality of coloring agents may be used in combination.

The content of the coloring agent is preferably from 1% by mass to 30% by mass inclusive and more preferably from 3% by mass to 15% by mass inclusive based on the total mass of the toner particles.

### Release Agent

Examples of the release agent include: hydrocarbon-based waxes; natural waxes such as carnauba wax, rice wax, and candelilla wax; synthetic and mineral/petroleum-based waxes such as montan wax; and ester-based waxes such as fatty acid esters and montanic acid esters. However, the release agent is not limited to these waxes.

The melting temperature of the release agent is preferably from 50° C. to 110° C. inclusive and more preferably from 60° C. to 100° C. inclusive.

The melting temperature is determined using a DSC curve obtained by differential scanning calorimetry (DSC) from “peak melting temperature” described in a melting temperature determination method in “Testing methods for transition temperatures of plastics” in JIS K7121-1987.

The content of the release agent is preferably from 1% by mass to 20% by mass inclusive and more preferably from 5% by mass to 15% by mass inclusive based on the total mass of the toner particles.

### Additional Additives

Examples of additional additives include well-known additives such as a magnetic material, a charge control agent, and an inorganic powder. These additives are contained in the toner particles as internal additives.

### Characteristics Etc. of Toner Particles

The toner particles may have a single layer structure or may have a so-called core-shell structure including a core (core particle) and a coating layer (shell layer) covering the core. Toner particles having the core-shell structure may each include, for example: a core containing a binder resin and optional additives such as a coloring agent and a release agent; and a coating layer containing a binder resin.

The volume average particle diameter (D50v) of the toner particles is preferably from 2 μm to 10 μm inclusive and more preferably from 4 μm to 8 μm inclusive.

The volume average particle diameter of the toner particles is measured using Coulter Multisizer II (manufactured by Beckman Coulter, Inc.), and ISOTON-II (manufactured by Beckman Coulter, Inc.) is used as an electrolyte. In the measurement, 0.5 mg to 50 mg of a measurement sample is added to 2 mL of a 5% by mass aqueous solution of a surfactant (which may be sodium alkylbenzenesulfonate) serving as a dispersant. The mixture is added to 100 mL to 150 mL of the electrolyte. The electrolyte with the sample suspended therein is subjected to dispersion treatment for 1 minute using an ultrasonic dispersion apparatus, and then the diameters of particles having diameters within the range of 2 μm to 60 μm are measured using an aperture having an aperture diameter of 100 μm in the Coulter Multisizer II. The number of particles sampled is 50000.

### External Additives

Examples of the external additives include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaOSiO₂, K₂O(TiO₂)ₙ, Al₂O₃·2SiO₂, CaCO₃, MgCO₃, BaSO₄, and MgSO₄.

The surfaces of the inorganic particles used as the external additive may be subjected to hydrophobic treatment. The hydrophobic treatment is performed, for example, by immersing the inorganic particles in a hydrophobic treatment agent. No particular limitation is imposed on the hydrophobic treatment agent. Examples of the hydrophobic treatment agent include silane-based coupling agents, silicone oils, titanate-based coupling agents, and aluminum-based coupling agents. These may be used alone or in combination of two or more.

The amount of the hydrophobic treatment agent is generally, for example, from 1 part by mass to 10 parts by mass inclusive based on 100 parts by mass of the inorganic particles.

Other examples of the external additives include resin particles (particles of resins such as polystyrene, polymethyl methacrylate, and melamine resin) and a cleaning lubricant (a metal salt of a higher fatty acid typified by zinc stearate or particles of a fluorine-based high-molecular weight material).

The amount of the external additives is preferably from 0.01% by mass to 5% by mass inclusive and more preferably from 0.01% by mass to 2.0% by mass inclusive based on the mass of the toner particles.

### Method for Producing Toner

The toner is obtained by externally adding the external additives to the toner particles produced. The toner particles may be produced by a dry production method (such as a kneading-grinding method) or by a wet production method (such as an aggregation/coalescence method or a dissolution/suspension method). No particular limitation is imposed on the production method, and any known production method may be used. In particular, the aggregation/coalescence method may be used to obtain the toner particles.

### Image Forming Apparatus and Image Forming Method

An image forming apparatus/an image forming method in an exemplary embodiment will be described.

The image forming apparatus in the present exemplary embodiment includes: an image holding member; a charging device that charges the surface of the image holding member; an electrostatic image forming device that forms an electrostatic image on the charged surface of the image holding member; a developing device that houses an electrostatic image developer and develops the electrostatic image formed on the surface of the image holding member with the electrostatic image developer to thereby form a toner image; a transferring device that transfers the toner image formed on the surface of the image holding member onto a surface of a recording medium; and a fixing device that fixes the toner image transferred onto the surface of the recording medium. The electrostatic image developer used is the electrostatic image developer according to the preceding exemplary embodiment.

In the image forming apparatus in the present exemplary embodiment, an image forming method (an image forming method in the present exemplary embodiment) is performed. The image forming method includes: charging the surface of the image holding member; forming an electrostatic image on the charged surface of the image holding member; developing the electrostatic image formed on the surface of the image holding member with the electrostatic image developer according to the preceding exemplary embodiment to thereby form a toner image; transferring the toner image formed on the surface of the image holding member onto a surface of a recording medium; and fixing the toner image transferred onto the surface of the recording medium.

The image forming apparatus in the present exemplary embodiment may be applied to known image forming apparatuses such as: a direct transfer-type apparatus that transfers a toner image formed on the surface of the image holding member directly onto a recording medium; an intermediate transfer-type apparatus that first-transfers a toner image formed on the surface of the image holding member onto the surface of an intermediate transfer body and second-transfers the toner image transferred onto the surface of the intermediate transfer body onto the surface of a recording medium; an apparatus including a cleaning device that cleans the surface of the image holding member after the transfer of the toner image but before charging; and an apparatus including a charge eliminating device that eliminates charges on the surface of the image holding member after transfer of the toner image but before charging by irradiating the surface of the image holding member with charge eliminating light.

When the image forming apparatus in the present exemplary embodiment is the intermediate transfer-type apparatus, the transferring device includes, for example: an intermediate transfer body having a surface onto which a toner image is to be transferred; a first transferring device that first-transfers a toner image formed on the surface of the image holding member onto the surface of the intermediate transfer body; and a second transferring device that second-transfers the toner image transferred onto the surface of the intermediate transfer body onto the surface of a recording medium.

In the image forming apparatus in the present exemplary embodiment, for example, a portion including the developing device may have a cartridge structure (process cartridge) that is detachably attached to the image forming apparatus. The process cartridge used may be, for example, a process cartridge including the developing device that houses the electrostatic image developer according to the preceding exemplary embodiment.

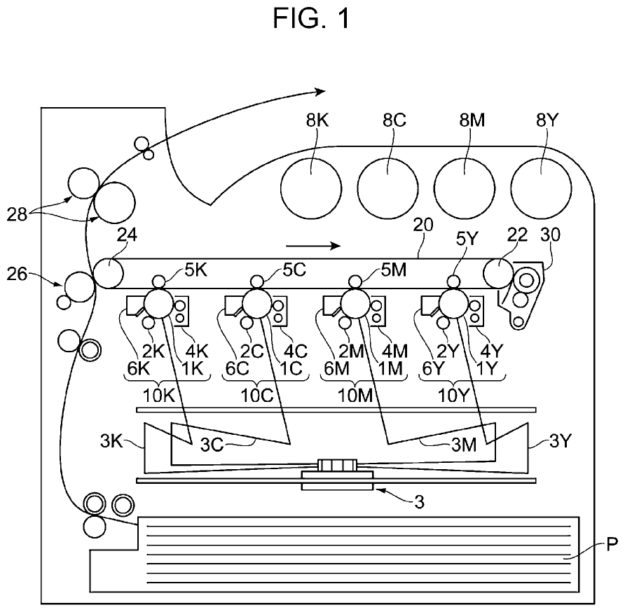

An example of the image forming apparatus in the present exemplary embodiment will be described, but this is not a limitation. In the following description, major components shown in FIG. 1 will be described, and description of other components will be omitted.

FIG. 1 is a schematic configuration diagram showing the image forming apparatus in the present exemplary embodiment.

The image forming apparatus shown in FIG. 1 includes first to fourth electrophotographic image forming units 10Y, 10M, 10C, and 10K (image forming devices) that output yellow (Y), magenta (M), cyan (C), and black (K) images, respectively, based on color-separated image data. These image forming units (hereinafter may be referred to simply as “units”) 10Y, 10M, 10C, and 10K are arranged so as to be spaced apart from each other horizontally by a prescribed distance. These units 10Y, 10M, 10C, and 10K may each be a process cartridge detachably attached to the image forming apparatus.

An intermediate transfer belt (an example of the intermediate transfer body) 20 is disposed above the units 10Y, 10M, 10C, and 10K so as to extend through these units. The intermediate transfer belt 20 is wound around a driving roller 22 and a support roller 24 that are in contact with the inner surface of the intermediate transfer belt 20 and runs in a direction from the first unit 10Y toward the fourth unit 10K. A force is applied to the support roller 24 by, for example, an unillustrated spring in a direction away from the driving roller 22, so that a tension is applied to the intermediate transfer belt 20 wound around the rollers. An intermediate transfer belt cleaner 30 is disposed on an image holding surface side of the intermediate transfer belt 20 so as to be opposed to the driving roller 22.

Yellow, magenta, cyan, and black toners contained in toner cartridges 8Y, 8M, 8C, and 8K, respectively, are supplied to developing units (examples of the developing device) 4Y, 4M, 4C, and 4K, respectively, of the units 10Y, 10M, 10C, and 10K.

The first to fourth units 10Y, 10M, 10C, and 10K have the same structure and operate similarly. Therefore, the first unit 10Y that is disposed upstream in the running direction of the intermediate transfer belt and forms a yellow image will be described as a representative unit.

The first unit 10Y includes a photoconductor 1Y serving as an image holding member. A charging roller (an example of the charging device) 2Y, an exposure unit (an example of the electrostatic image forming device) 3, a developing unit (an example of the developing device) 4Y, a first transfer roller 5Y (an example of the first transferring device), and a photoconductor cleaner (an example of the image holding member cleaning device) 6Y are disposed around the photoconductor 1Y in this order. The charging roller charges the surface of the photoconductor 1Y to a prescribed potential, and the exposure unit 3 exposes the charged surface to a laser beam 3Y according to a color-separated image signal to thereby form an electrostatic image. The developing unit 4Y supplies a charged toner to the electrostatic image to develop the electrostatic image, and the first transfer roller 5Y transfers the developed toner image onto the intermediate transfer belt 20. The photoconductor cleaner 6Y removes the toner remaining on the surface of the photoconductor 1Y after the first transfer.

The first transfer roller 5Y is disposed on the inner side of the intermediate transfer belt 20 and placed at a position opposed to the photoconductor 1Y. Bias power sources (not shown) for applying a first transfer bias are connected to the respective first transfer rollers 5Y, 5M, 5C, and 5K of the units. The bias power sources are controlled by an unillustrated controller to change the values of transfer biases applied to the respective first transfer rollers.

A yellow image formation operation in the first unit 10Y will be described.

First, before the operation, the surface of the photoconductor 1Y is charged by the charging roller 2Y to a potential of −600 V to —800 V.

The photoconductor 1Y is formed by stacking a photosensitive layer on a conductive substrate (with a volume resistivity of, for example, 1×10⁻⁶ Ωcm or less at 20° C.). The photosensitive layer generally has a high resistance (the resistance of a general resin) but has the property that, when irradiated with a laser beam, the specific resistance of a portion irradiated with the laser beam is changed. Therefore, the charged surface of the photoconductor 1Y is irradiated with a laser beam 3Y from the exposure unit 3 according to yellow image data sent from an unillustrated controller. An electrostatic image with a yellow image pattern is thereby formed on the surface of the photoconductor 1Y.

The electrostatic image is an image formed on the surface of the photoconductor 1Y by charging and is a negative latent image formed as follows. The specific resistance of the irradiated portions of the photosensitive layer irradiated with the laser beam 3Y decreases, and this causes charges on the surface of the photoconductor 1Y to flow. However, the charges in portions not irradiated with the laser beam 3Y remain present, and the electrostatic image is thereby formed.

The electrostatic image formed on the photoconductor 1Y rotates to a prescribed developing position as the photoconductor 1Y rotates. Then the electrostatic image on the photoconductor 1Y at the developing position is developed and visualized as a toner image by the developing unit 4Y.

An electrostatic image developer containing, for example, at least a yellow toner and a carrier is contained in the developing unit 4Y. The yellow toner is agitated in the developing unit 4Y and thereby frictionally charged. The charged yellow toner has a charge with the same polarity (negative polarity) as the charge on the photoconductor 1Y and is held on a developer roller (an example of a developer holding member). As the surface of the photoconductor 1Y passes through the developing unit 4Y, the yellow toner electrostatically adheres to charge-eliminated latent image portions on the surface of the photoconductor 1Y, and the latent image is thereby developed with the yellow toner. Then the photoconductor 1Y with the yellow toner image formed thereon continues running at a prescribed speed, and the toner image developed on the photoconductor 1Y is transported to a prescribed first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to, for example, +10 μA in the first unit 10Y by the controller (not shown).

The toner remaining on the photoconductor 1Y is removed and collected by the photoconductor cleaner 6Y.

The first transfer biases applied to first transfer rollers 5M, 5C, and 5K of the second unit 10M and subsequent units are controlled in the same manner as in the first unit.

The intermediate transfer belt 20 with the yellow toner image transferred thereon in the first unit 10Y is sequentially transported through the second to fourth units 10M, 10C and 10K, and toner images of respective colors are superimposed and multi-transferred.

Then the intermediate transfer belt 20 with the four color toner images multi-transferred thereon in the first to fourth units reaches a secondary transfer portion that is composed of the intermediate transfer belt 20, the support roller 24 in contact with the inner surface of the intermediate transfer belt, and a secondary transfer roller (an example of the second transferring device) 26 disposed on the image holding surface side of the intermediate transfer belt 20. A recording paper sheet (an example of the recording medium) P is supplied to a gap between the secondary transfer roller 26 and the intermediate transfer belt 20 in contact with each other at a prescribed timing through a supply mechanism, and a secondary transfer bias is applied to the support roller 24. The transfer bias applied in this case has the same polarity (−) as the polarity (−) of the toner, and an electrostatic force directed from the intermediate transfer belt 20 toward the recording paper sheet P acts on the toner image, so that the toner image on the intermediate transfer belt 20 is transferred onto the recording paper sheet P. In this case, the secondary transfer bias is determined according to a resistance detected by a resistance detection device (not shown) that detects the resistance of the secondary transfer portion and is voltage-controlled.

Then the recording paper sheet P with the toner image transferred thereon is transported to a press contact portion (nip portion) of a pair of fixing rollers in a fixing unit (an example of the fixing device) 28, and the toner image is fixed onto the recording paper sheet P to thereby form a fixed image. The recording paper sheet P with the color image fixed thereon is transported to an ejection portion, and a series of the color image formation operations is thereby completed.

Examples of the recording paper sheet P onto which a toner image is to be transferred include plain paper sheets used for electrophotographic copying machines, printers, etc. Examples of the recording medium include, in addition to the recording paper sheets P, transparencies.

To further improve the smoothness of the surface of a fixed image, it may be necessary that the surface of the recording paper sheet P be smooth. For example, coated paper prepared by coating the surface of plain paper with, for example, a resin, art paper for printing, etc. are suitably used.

### Process Cartridge

A process cartridge in an exemplary embodiment will be described.

The process cartridge according to the present exemplary embodiment includes a developing device that houses the electrostatic image developer according to the preceding exemplary embodiment and develops an electrostatic image formed on the surface of an image holding member with the electrostatic image developer to thereby form a toner image. The process cartridge is detachably attached to the image forming apparatus.

The process cartridge according to the present exemplary embodiment may include the developing device and at least one optional device selected from other devices such as an image holding member, a charging device, an electrostatic image forming device, and a transferring device.

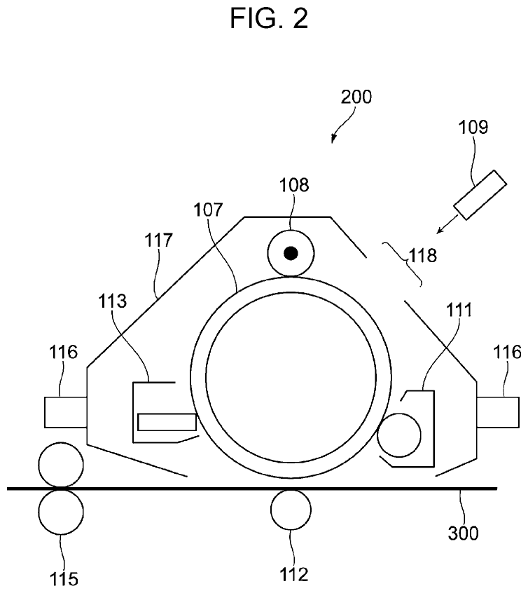

An example of the process cartridge according to the present exemplary embodiment will be described, but this is not a limitation. In the following description, major components shown in FIG. 2 will be described, and description of other components will be omitted.

FIG. 2 is a schematic configuration diagram showing an example of the process cartridge according to the present exemplary embodiment.

The process cartridge 200 shown in FIG. 2 includes, for example, a housing 117 including mounting rails 116 and an opening 118 for light exposure and further includes a photoconductor 107 (an example of the image holding member), a charging roller 108 (an example of the charging device) disposed on the circumferential surface of the photoconductor 107, a developing unit 111 (an example of the developing device), and a photoconductor cleaner 113 (an example of the cleaning device), which are integrally combined and held in the housing 117 to thereby form a cartridge.

In FIG. 2, 109 denotes an exposure unit (an example of the electrostatic image forming device), and 112 denotes a transferring unit (an example of the transferring device). 115 denotes a fixing unit (an example of the fixing device), and 300 denotes a recording paper sheet (an example of the recording medium).

### Examples

The exemplary embodiments of the disclosure will be described in detail by way of Examples. However, the exemplary embodiments of the disclosure are not limited to these Examples. In the following description, “parts” and “%” are based on mass, unless otherwise specified.

### Production of Toner

### Preparation of Resin Particle Dispersion (1)

| | |
|---|---|
| Ethylene glycol | 37 parts |
| (FUJIFILM Wako Pure | |
| Chemical Corporation) | |
| Neopentyl glycol | 65 parts |
| (FUJIFILM Wako Pure | |
| Chemical Corporation) | |
| 1,9-Nonanediol | 32 parts |
| (FUJIFILM Wako Pure | |
| Chemical Corporation) | |
| Terephthalic acid | 96 parts |
| (FUJIFILM Wako Pure | |
| Chemical Corporation) | |

The above materials are placed in a flask and heated to a temperature of 200° C. over 1 hour. After confirmation that the reaction system has been uniformly stirred, 1.2 parts of dibutyl tin oxide is added. While water produced is removed by evaporation, the temperature is increased to 240° C. over 6 hours, and the stirring is continued at 240° C. for 4 hours to thereby obtain a polyester resin (acid value: 9.4 mgKOH/g, weight average molecular weight: 13000, glass transition temperature: 62° C.). This polyester resin in a molten state is transferred to an emulsifying-dispersing apparatus (CAVITRON CD1010, EUROTEC Co., Ltd.) at a rate of 100 g/minute. Separately, diluted ammonia water prepared by diluting reagent ammonia water with ion exchanged water to a concentration of 0.37% is placed in a tank. While heated to 120° C. using a heat exchanger, the diluted ammonia water, together with the polyester resin, is transferred to the emulsifying-dispersing apparatus at a rate of 0.1 L/minute. The emulsifying-dispersing apparatus is operated under the following conditions: rotor rotation speed: 60 Hz; and pressure: 5 kg/cm². A resin particle dispersion (1) with a volume average particle diameter of 160 nm and a solid content of 30% is thereby obtained.

### Preparation of Resin Particle Dispersion (2)

| | |
|---|---|
| Decanedioic acid (TOKYO | 81 parts |
| CHEMICAL INDUSTRY Co., Ltd.) | |
| Hexanediol (FUJIFILM Wako Pure | 47 parts |
| Chemical Corporation) | |

The above materials are placed in a flask and heated to a temperature of 160° C. over 1 hour. After confirmation that the reaction system has been uniformly stiffed, 0.03 parts of dibutyl tin oxide is added. While water produced is removed by evaporation, the temperature is increased to 200° C. over 6 hours, and the stirring is continued at 200° C. for 4 hours. Then the reaction solution is cooled and subjected to solid-liquid separation. The solid is dried at a temperature of 40° C. under reduced pressure to thereby obtain a polyester resin (C1) (melting point: 64° C., weight average molecular weight: 15000).

| | |
|---|---|
| Polyester resin (C1) | 50 parts |
| Anionic surfactant (Neogen SC, | 2 parts |
| DAI-ICHI KOGYO SEIYAKU Co., Ltd.) | |
| Ion exchanged water | 200 parts |

The above materials are heated to 120° C., sufficiently dispersed using a homogenizer (ULTRA-TURRAX T50, IKA), and then subjected to dispersion treatment using a pressure discharge-type homogenizer. When the volume average particle diameter reaches 180 nm, the product is collected, and a resin particle dispersion (2) with a solid content of 20% is thereby obtained.

### Preparation of Coloring Agent Particle Dispersion (1)

| | |
|---|---|
| Cyan pigment (Pigment Blue 15:3, | 10 parts |
| Dainichiseika Color & Chemicals Mfg. Co., Ltd.) | |
| Anionic surfactant (Neogen SC, | 2 parts |
| DAI-ICHI KOGYO SEIYAKU Co., Ltd.) | |
| Ion exchanged water | 80 parts |

The above materials are mixed and dispersed for 1 hour using a high-pressure impact disperser (Ultimaizer HJP30006, Sugino Machine Limited) to thereby obtain a coloring agent particle dispersion (1) with a volume average particle diameter of 180 nm and a solid content of 20%.

### Preparation of Release Agent Particle Dispersion (1)

| | |
|---|---|
| Paraffin wax (HNP-9, Nippon Seiro Co., Ltd.) | 50 parts |
| Anionic surfactant (Neogen SC, | 2 parts |
| DAI-ICHI KOGYO SEIYAKU Co., Ltd.) | |
| Ion exchanged water | 200 parts |

The above materials are heated to 120° C., sufficiently dispersed using a homogenizer (ULTRA-TURRAX T50, IKA), and then subjected to dispersion treatment using a pressure discharge-type homogenizer. When the volume average particle diameter reaches 200 nm, the product is collected, and a release agent particle dispersion (1) with a solid content of 20% is thereby obtained.

### Production of Toner (1)

| | |
|---|---|
| Resin particle dispersion (1) | 150 parts |
| Resin particle dispersion (2) | 50 parts |
| Coloring agent particle dispersion (1) | 25 parts |
| Release agent particle dispersion (1) | 35 parts |
| Aluminum polychloride | 0.4 parts |
| Ion exchanged water | 100 parts |

The above materials are placed in a stainless steel-made round flask, mixed and dispersed sufficiently using a homogenizer (ULTRA-TURRAXT50, IKA), and then heated to 48° C. in an oil bath for heating while the mixture in the flask is stirred. The reaction system is held at 48° C. for 60 minutes, and then an additional 70 parts of the resin particle dispersion (1) is gently added. Next, a 0.5 mol/L aqueous sodium hydroxide solution is used to adjust the pH to 8.0. The flask is hermetically sealed, and a stirring shaft is magnetically sealed. While the stirring is continued, the reaction system is heated to 90° C. and held for 30 minutes. Next, the reaction system is cooled at a cooling rate of 5° C./minute, subjected to solid-liquid separation, and washed sufficiently with ion exchanged water. Then the mixture is subjected to solid-liquid separation, re-dispersed in ion exchanged water at 30° C., and washed by stirring at a rotation speed of 300 rpm for 15 minutes. This washing procedure is repeated 6 times. When the pH of the filtrate reaches 7.54 and its electric conductivity reaches 6.5 μS/cm, the mixture is subjected to solid-liquid separation, and vacuum drying is performed for 24 hours to thereby obtain toner particles (1) with a volume average particle diameter of 5.7 μm.

100 Parts of the toner particles (1) and 0.7 parts of hydrophobic silica (RY50 manufactured by Nippon Aerosil Co., Ltd.) are mixed using a Henschel mixer to obtain a toner (1)

### Production of Carrier

### Preparation of Core Material

### Ferrite Particles

74 Parts of Fe₂O₃, 4 parts of Mg(OH)₂, and 21 parts of MnO₂ are mixed, and then the mixture is calcinated using a rotary kiln under the conditions of temperature: 950° C./7 hours (first calcination). The calcinated product is pulverized for 7 hours using a wet ball mill to adjust the average particle diameter to 2.0 μm, and the pulverized product is granulated using a spray dryer. The granulated product is calcinated using a rotary kiln under the conditions of temperature: 950° C./6 hours (second calcination). The calcinated product is pulverized for 3 hours using a wet ball mill to adjust the average particle diameter to 5.6 μm, and the pulverized product is granulated using a spray dryer. The granulated product is fired using an electric furnace under the conditions of temperature:

1300° C./5 hours. The fired product obtained is pulverized and classified to thereby obtain ferrite particles having a volume average particle diameter of 32 μm.

### Preparation of Nitrogen-Containing Silica Particles

### Nitrogen-Containing Silica Particles (1)

8 Parts of silica (volume average particle diameter: 12 nm) is added to 100 parts of toluene, and the mixture is stirred and dispersed using an ultrasonic disperser. 2 Parts of 3-aminopropyltriethoxysilane is added to the mixture, and the resulting mixture is stirred at room temperature for 1 hour. Then toluene is removed by evaporation, and the resulting mixture is dried and heated at 120° C. for 30 minutes to complete the reaction of the aminosilane polymer. Nitrogen-containing silica particles (1) treated with the aminosilane (mass ratio of silica: aminosilane=8:2) are thereby obtained.

### Nitrogen-Containing Silica Particles (2) to (7)

Nitrogen-containing silica particles (2) to (7) are obtained using the same procedure as for the nitrogen-containing silica particles (1) except that silica having a volume average particle diameter of 3 nm, 5 nm, 8 nm, 15 nm, 20 nm, or 33 nm is used instead of the silica having a volume average particle diameter of 12 nm.

### Preparation of Nitrogen-Containing Resin Fine Particles

Crosslinked melamine resin fine particles having a volume average particle diameter of 100 nm, 150 nm, 200 nm, 250 nm, or 300 nm are used as the nitrogen-containing resin fine particles.

### Example 1

| | |
|---|---|
| Ferrite particles | 100 parts |
| Nitrogen-containing silica | 1.55 parts (30% by mass based on the |
| particles (1) | total mass of the resin coating layer) |
| Nitrogen-containing resin | 0.55 parts (10% by mass based on the |
| fine particles (volume | total mass of the resin coating layer) |
| average particle diameter: | (the mass ratio of the nitrogen-containing |
| 200 nm) | resin fine particles/the nitrogen- |
| | containing silica particles: 0.33) |
| Cyclohexyl methacrylate/ | 3 parts |
| methyl methacrylate | |
| copolymer (copolymerization | |
| ratio: 95 moles:5 moles) | |
| Toluene | 14 parts |

Among the above materials, the nitrogen-containing silica particles (1), the nitrogen-containing resin fine particles, the cyclohexyl methacrylate/methyl methacrylate copolymer, and toluene, together with glass beads (diameter: 1 mm, the same amount as toluene), are placed in a sand mill (Kansai Paint Co., Ltd.) and stirred at a rotation speed of 1200 rpm for 30 minutes to obtain a resin layer-forming solution (1).

The ferrite particles are placed in a vacuum degassed-type kneader, and then the resin layer-forming solution (1) is placed in the kneader. While the pressure inside the kneader is reduced, the temperature thereinside is increased under stirring to remove toluene by evaporation, and the ferrite particles are thereby coated with the resin. Then fine powders and coarse powders are removed using an Elbow-Jet to thereby obtain a carrier.

### Examples 2 to 20

Carriers in Examples 2 to 20 are produced using the same procedure as in Example 1 except that the type and content of the nitrogen-containing silica particles and the type and content of the nitrogen-containing resin fine particles are changed as shown in Table 1.

### Comparative Examples 1 and 2

Carriers are produced using the same procedure as in Example 1 except that the type and content of the nitrogen-containing silica particles and the type and content of the nitrogen-containing resin fine particles are changed as shown in Table 1.

### Properties of Carriers

For each of the carriers obtained in Examples 1 to 20 and Comparative Examples 1 to 2, the following values are determined and shown in Table 1.

### Thickness T of Resin Coating Layer (μm)

The method described above is used to measure the thickness T.

### D/T (the Volume Average Particle Diameter of the Nitrogen-Containing Resin Fine Particles/the Thickness of the Resin Coating Layer)

The volume average particle diameter of the nitrogen-containing resin fine particles, e.g., 100 nm, is converted to μm to determine D (μm), and D/T is determined using the thickness T (μm) of the resin coating layer.

TABLE 1

| | | | Nitrogen- | | | | | |
|---|---|---|---|---|---|---|---|---|
| | | | containing | Volume | Volume | | | |
| | | | resin fine | average | average | | | |
| | Content of | Content of | particles/ | diameter of | diameter of | Properties of carrier | | |
| | nitrogen- | nitrogen- | nitrogen- | nitrogen- | nitrogen- | Thickness T | | Evaluation |
| | containing | containing | containing silica | containing | containing | of resin | | of charge |
| | silica | resin fine | particles (mass | resin fine | silica | coating | | retention |
| | particles (%) | particles (%) | ratio) | particles (nm) | particles (nm) | layer (μm) | D/T | ability |
| Example 1 | 30 | 10 | 0.33 | 200 | 12 | 1 | 0.20 | A |
| Example 2 | 40 | 13 | 0.33 | 200 | 12 | 1 | 0.20 | A |
| Example 3 | 20 | 7 | 0.33 | 200 | 12 | 1 | 0.20 | A |
| Example 4 | 30 | 15 | 0.50 | 200 | 12 | 1 | 0.20 | A |
| Example 5 | 30 | 6 | 0.20 | 200 | 12 | 1 | 0.20 | A |
| Example 6 | 30 | 10 | 0.33 | 250 | 12 | 1 | 0.25 | B |
| Example 7 | 30 | 10 | 0.33 | 230 | 12 | 1 | 0.23 | A |
| Example 8 | 30 | 10 | 0.33 | 120 | 12 | 1 | 0.12 | A |
| Example 9 | 30 | 10 | 0.33 | 150 | 12 | 1 | 0.15 | A |
| Example 10 | 30 | 10 | 0.33 | 200 | 15 | 1 | 0.20 | A |
| Example 11 | 30 | 10 | 0.33 | 200 | 8 | 1 | 0.20 | A |
| Example 12 | 55 | 18 | 0.33 | 200 | 12 | 1 | 0.20 | B |
| Example 13 | 10 | 3 | 0.33 | 200 | 12 | 1 | 0.20 | B |
| Example 14 | 30 | 17 | 0.55 | 200 | 12 | 1 | 0.20 | B |
| Example 15 | 30 | 5 | 0.15 | 200 | 12 | 1 | 0.20 | B |
| Example 16 | 30 | 10 | 0.33 | 100 | 12 | 1 | 0.10 | B |
| Example 17 | 30 | 10 | 0.33 | 200 | 20 | 1 | 0.20 | B |
| Example 18 | 30 | 10 | 0.33 | 200 | 5 | 1 | 0.20 | B |
| Example 19 | 30 | 10 | 0.33 | 200 | 33 | 1 | 0.20 | C |
| Example 20 | 30 | 10 | 0.33 | 200 | 3 | 1 | 0.20 | C |
| Comparative | 30 | 10 | 0.33 | 300 | 12 | 1 | 0.30 | D |
| Example 1 | | | | | | | | |
| Comparative | 60 | 20 | 0.33 | 200 | 12 | 1 | 0.20 | D |
| Example 2 | | | | | | | | |

In Table 1, the content of the nitrogen-containing silica particles means the content based on the total mass of the resin coating layer.

In Table 1, the content of the nitrogen-containing resin fine particles means the content based on the total mass of the resin coating layer.

### Preparation of Developers

100 Parts of one of the carriers in Examples 1 to 20 and Comparative Examples 1 and 2 and 8.5 parts of the toner (1) are mixed. Twenty two different developers are thereby prepared. The developers prepared are used for the evaluation of the charge retention ability described below.

### Evaluation of Charge Retention Ability of Developers

One of the developers is placed in a black developing unit of an image forming apparatus (“Iridesse Production Press” manufactured by FUJIFILM Business Innovation Corp.). In a low-temperature low-humidity environment (10° C., 15 RH %), printing is performed on a total of 50000 A4 sheets using the above image forming apparatus under the condition of 100 sheets per job. 20 g of the developer is sampled at the beginning, and another 20 g is sampled after printing on 50000 sheets. Air is blown onto each sample to remove the toner from the developer, and the carrier is thereby isolated. 0.8 g of the toner used to produce the developer is newly added to 10 g of the carrier obtained. Then the mixture is stirred using a Turbula mixer for 5 minutes, and the amount of charges is measured.

The ratio of the amount of charges on the carrier in the developer after printing on 50000 sheets to the amount of charges on the carrier in the developer at the beginning is computed, and the charge retention ability of the toner is evaluated according to criteria below. The results are shown in Table 1.
A: The charge amount ratio of the carrier is 0.9 or more.
B: The charge amount ratio of the carrier is 0.8 or more and less than 0.9.
C: The charge amount ratio of the carrier is 0.7 or more and less than 0.8.
D: The charge amount ratio of the carrier is less than 0.7.
As can be seen from Table 1, in the carriers for electrostatic image development in the Examples, deterioration in the charge retention ability is less than that in the carriers for electrostatic image development in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A carrier for electrostatic image development comprising:
a core material; and
a resin coating layer that contains nitrogen-containing silica particles and nitrogen-containing resin fine particles and covers the core material,
wherein the content of the nitrogen-containing silica particles is from 10% by mass to 55% by mass inclusive based on the total mass of the resin coating layer,
wherein the nitrogen-containing resin fine particles have a volume average particle diameter of from 100 nm to 250 nm inclusive, and
wherein the mass ratio P/S of the mass P of the nitrogen-containing resin fine particles to the mass S of the nitrogen-containing silica particles is from 0.15 to 0.55 inclusive.

2. The carrier for electrostatic image development according to claim 1, wherein the nitrogen-containing silica particles include silica particles treated with a silane coupling agent having a nitrogen-containing functional group or a vinyl-based copolymer synthesized using a (meth)acrylic monomer having a nitrogen-containing functional group and a hydrolyzable alkoxy silanol group.

3. The carrier for electrostatic image development according to claim 2, wherein the silane coupling agent having a nitrogen-containing functional group has an amino group and a hydrolyzable alkoxy silanol group.

4. The carrier for electrostatic image development according to claim 3, wherein the nitrogen-containing silica particles have a volume average particle diameter of from 5 nm to 20 nm inclusive.

5. The carrier for electrostatic image development according to claim 1, wherein D/T is from 0.007 to 0.24 inclusive, where D is the volume average particle diameter (μm) of the nitrogen-containing resin fine particles, and T is the thickness (μm) of the resin coating layer.

6. The carrier for electrostatic image development according to claim 5, wherein the content of the nitrogen-containing resin fine particles is from 5% by mass to 30% by mass inclusive based on the total mass of the resin coating layer.

7. The carrier for electrostatic image development according to claim 5, wherein the volume average particle diameter of the nitrogen-containing resin fine particles is from 120 nm to 230 nm inclusive.

8. The carrier for electrostatic image development according to claim 1, wherein the resin coating layer further contains an alicyclic (meth)acrylic resin.

9. The carrier for electrostatic image development according to claim 8, wherein the alicyclic (meth)acrylic resin contains cyclohexyl (meth)acrylate as a monomer component.

10. The carrier for electrostatic image development according to claim 1, wherein the content of the nitrogen-containing silica particles is from 13% by mass to 50% by mass inclusive based on the total mass of the resin coating layer.

11. The carrier for electrostatic image development according to claim 10, wherein the mass ratio P/S of the mass P of the nitrogen-containing resin fine particles to the mass S of the nitrogen-containing silica particles is from 0.18 to 0.52 inclusive.

12. An electrostatic image developer comprising:
a toner for electrostatic image development; and
the carrier for electrostatic image development according to claim 1.

13. A process cartridge detachably attached to an image forming apparatus, the process cartridge comprising:
a developing device that houses the electrostatic image developer according to claim 12 and develops, as a toner image, an electrostatic image formed on a surface of an image holding member using the electrostatic image developer.

14. An image forming apparatus comprising:
an image holding member;
a charging device that charges a surface of the image holding member;
an electrostatic image forming device that forms an electrostatic image on the charged surface of the image holding member;
a developing device that houses the electrostatic image developer according to claim 12 and develops the electrostatic image formed on the surface of the image holding member as a toner image using the electrostatic image developer;
a transfer device that transfers the toner image formed on the surface of the image holding member onto a surface of a recording medium; and
a fixing device that fixes the toner image transferred onto the surface of the recording medium.

15. An image forming method comprising:
charging a surface of an image holding member;
forming an electrostatic image on the charged surface of the image holding member;
developing the electrostatic image formed on the surface of the image holding member as a toner image using the electrostatic image developer according to claim 12;
transferring the toner image formed on the surface of the image holding member onto a surface of a recording medium; and
fixing the toner image transferred onto the surface of the recording medium.
